(19) United States
(12) Patent Application Publication
(10) Pub. No.: US 2023/0295985 A1
(43) Pub. Date: Sep. 21, 2023

(54) CONE AND CLAMP ASSEMBLY FOR SCREEN ASSEMBLY

(71) Applicant: CENTOR DESIGN PTY LTD, Queensland (AU)

(72) Inventor: Christopher Paul SMITH, Queensland (AU)

(73) Assignee: CENTOR DESIGN PTY LTD, Queensland (AU)

(21) Appl. No.: 18/003,443

(22) PCT Filed: Jun. 28, 2021
(86) PCT No.: PCT/AU2021/050683

§ 371 Date: Dec. 27, 2022

(30) Foreign Application Priority Data
Jun. 30, 2020 (AU) 2020902215

(51) Int. Cl. E06B 9/54

(52) U.S. Cl. CPC E06B 9/54; E06B 2009/543

(57) ABSTRACT

A cone and clamp assembly for a screen assembly comprises a substantially vertical supporting member about which a screen can be wound/unwound, a cone associated with at least one end of the supporting member and rotatable with the supporting member and at least one line member that can be wound onto and off the cone. The cone and clamp assembly comprises a clamp configured to hold the at least one line member relative to an external surface of the cone in an engaged position during transportation of the screen assembly or prior to operation of the screen assembly, a drive plate engaged with a pivot pin of the clamp, a cone plate coupled to the cone through the drive plate and the clamp, and an adjustable element coupled between the cone plate and the drive plate. Adjustment of the adjustable element in a first direction rotates the clamp toward the external surface of the cone and adjustment of the adjustable element in a second direction rotates the clamp away from the external surface of the cone.

### FIELD OF THE INVENTION

The present invention is directed to mechanisms for screen assemblies and the like that can be used in a window or door cavity, or any other area which may benefit from the assembly and which contains a flexible sheet like member (for instance an insect screen). The invention is particularly directed to a cone and clamp assembly for screen assemblies where the flexible sheet like member is wound about a rod or the like, and where the rod is positioned substantially vertically such that the screen extends and retracts in a horizontal direction.

### BACKGROUND

It is well known to provide a roll up, or retractable, screen assembly that can extend across a window or door. In most cases, a flexible screen can be wound about a wooden, metal or plastic rod or pole which is positioned in a substantially horizontal manner such that the screen assembly can be pulled up or pulled down in a vertical direction. A holland blind is an example of this type of screen assembly.

It is also known to provide a retractable screen assembly that can move in a horizontal direction across a window or door cavity, and with this type of assembly, the screen, for instance a fabric or mesh, can be wound about a substantially vertical rod or pole, which is typically located at one side of the cavity.

The present invention is directed primarily to a screen assembly that can move horizontally across a window or door cavity. However, there may be parts of the invention which may find suitability in “up and down” screens or screens which are extended and retracted in other manners.

Australian patent AU 2006324373, which is incorporated herein by reference, discloses the Applicant's balanced screen system that uses springs, cables and a tapered pulley in the form of a drum or cone. The invention works because the diameter of the path of the cable on the cone is exactly the same as the changing diameter of the fabric or mesh as it rolls on and off the substantially vertical rod, pole or tube.

One problem with the screen disclosed in AU 2006324373 was that if and when the cable fell off the cone, for example during transportation or installation, it was generally beyond the skill of an installer to rewind the cable the correct number of turns to match the fabric or mesh on the roll on the substantially vertical rod, pole or tube. This led to the Applicant introducing a close-fitting cone cover, as disclosed in AU 2013317698, which is incorporated herein by reference.

Subsequently, the Applicant developed a smaller screen with a narrower frame. The cone cover took up a lot of room around the cone which forced the screen box to be wider than is desired. As a result, a thinner cone clip was developed by the Applicant, as disclosed in AU 2018204907, which is incorporated herein by reference.

However, the cone clip has not been as successful as the Applicant anticipated and has a number of disadvantages. For example, it is considered that the cone clip does not hold the cable firmly enough such that the cable can still fall off the cone. Also, the cone clip is impossible to replace. Another disadvantage is that although the cone clip works well on larger screens, it cannot be used where there is not enough room. It is also too expensive for smaller screens for which the market has an expectation of a lower price. One of the reasons the cone and clip are so expensive is that a very close fit is required between each of them to avoid unwanted noise or friction. CNC machining is typically used to obtain the necessary precision which has both high capital and high running costs.

The reference to any prior art in this specification is not, and should not be taken as, an acknowledgement or any form of suggestion that the prior art forms part of the common general knowledge.

### OBJECT OF THE INVENTION

A preferred object of the present invention is to provide an assembly, and in particular, a cone and clamp assembly, that addresses, or at least ameliorates one or more of the aforementioned problems and/or provides a useful commercial alternative.

### SUMMARY OF INVENTION

Generally, the present invention is directed to a cone and clamp assembly, that prevents the cable from falling off, or otherwise being detached from the cone, for example during transportation or installation, which is applicable to both larger and smaller screens.

According to one aspect, but not necessarily the broadest aspect, the present invention resides in a cone and clamp assembly for a screen assembly comprising:
a substantially vertical supporting member about which a screen can be wound/unwound;
a cone associated with at least one end of the supporting member and rotatable with the supporting member;
at least one line member that can be wound onto and off the cone;
a clamp configured to hold the at least one line member relative to an external surface of the cone in an engaged position during transportation of the screen assembly or prior to operation of the screen assembly;
a drive plate engaged with a pivot pin of the clamp;
a cone plate coupled to the cone through the drive plate and the clamp; and
an adjustable element coupled between the cone plate and the drive plate;
wherein adjustment of the adjustable element in a first direction rotates the clamp toward the external surface of the cone and adjustment of the adjustable element in a second direction rotates the clamp away from the external surface of the cone.

Preferably, the clamp comprises an inclined surface inclined at the same, or substantially the same angle as the external surface of the cone.

Preferably, the clamp comprises an upper surface extending from a top of the inclined surface, wherein the pivot pin protrudes from the upper surface.

Preferably, the clamp comprises a foot portion extending from a bottom of the inclined surface, the foot portion configured to engage an underside of the cone when the clamp is in the engaged position.

Preferably, the pivot pin is off-centre relative to the cone.

Preferably, the upper surface of the clamp comprises an aperture therethrough allowing a rod of the cone plate to pass therethrough.

Preferably, the line member enters and exits the cone at substantially 90 degrees to a direction of travel of the screen.

Preferably, the drive plate comprises an off-centre first aperture for receiving the pivot pin of the clamp.

Preferably, the drive plate comprises a substantially central second aperture allowing a rod of the cone plate to pass therethrough.

Preferably, the drive plate comprises a drive plate wall extending substantially perpendicularly from the drive plate for receiving the adjustable element.

Suitably, the cone plate comprises at least one cone plate wall extending substantially perpendicularly from the cone plate for receiving the adjustable element.

Preferably, the cone plate comprises a pair of spaced apart cone plate walls extending substantially perpendicularly from the cone plate for retaining part of the adjustable element therebetween.

Suitably, the drive plate wall is substantially parallel with, and spaced apart from, the at least one cone plate wall.

Suitably, the adjustable element is in the form of a screw extending through an aperture in the at least one cone plate wall and into an aperture in the drive plate wall.

Suitably, rotation of the screw in the first direction rotates the clamp toward the external surface of the cone and adjustment of the screw in a second direction rotates the clamp away from the external surface of the cone.

In some embodiments, the adjustable element is accessed through an aperture in an outer one of the pair of spaced apart cone plate walls.

Preferably, the clamping action of the clamp is at 90 degrees to the action of the adjustable element.

Suitably, the rod of the cone plate passes through, and is seated in a bearing, the bearing seated within the cone and secured in place with, for example, a C-clip.

According to another aspect, but not necessarily the broadest aspect, the present invention resides in a method of installing a screen assembly, the method comprising:
a. positioning a screen assembly relative to a window or door frame defining an opening, the screen assembly comprising:
   a substantially vertical supporting member about which a screen can be wound/unwound;
   a cone associated with at least one end of the supporting member and rotatable with the supporting member;
   at least one line member that can be wound onto and off the cone;
   a clamp configured to hold the at least one line member relative to an external surface of the cone in an engaged position during transportation of the screen assembly or prior to operation of the screen assembly;
   a drive plate engaged with a pivot pin of the clamp;
   a cone plate coupled to the cone through the drive plate and the clamp; and
   an adjustable element coupled between the cone plate and the drive plate, wherein the adjustable element has been adjusted in a first direction to rotate the clamp toward the external surface of the cone in the engaged position;
b. tensioning the at least one line member; and
c. adjusting the adjustable element in a second direction to rotate the clamp away from the external surface of the cone into a disengaged position.

Any of the features described herein can be combined in any combination with any one or more of the other features described herein within the scope of the invention.

Further features and/or aspects of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is an exploded view of a cone and clamp assembly in accordance with an embodiment of the present invention;

FIG. 2 is a plan view of the cone and clamp assembly shown in FIG. 1 in an assembled state situated in a jamb of a window or door cavity with the clamp activated;

FIG. 3 is a sectional view of the cone and clamp assembly shown in FIG. 2 along line A-A with the jamb omitted;

FIG. 4 is an enlarged view of region C in FIG. 3 showing the clamp adjacent the cone securing a line member in place on the cone;

FIG. 5 is a plan view of the cone and clamp assembly shown in FIG. 2 with the clamp released;

FIG. 6 is a sectional view of the cone and clamp assembly shown in FIG. 5 along line B-B with the jamb omitted;

FIG. 7 is an enlarged view of region D in FIG. 6 showing the clamp spaced apart from the cone;

FIG. 8 is a side view of the cone and clamp assembly shown in FIG. 2;

FIG. 9 is sectional plan view of the cone and clamp assembly along line A-A in FIG. 8;

FIG. 10 is a side view of the cone and clamp assembly shown in FIG. 5; and

FIG. 11 is sectional plan view of the cone and clamp assembly along line B-B in FIG. 10.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF EMBODIMENTS

The cone and clamp assembly of the present invention is for use with a wide range of screen assemblies. An example of such a screen assembly is described in AU 2018204907, which is incorporated herein by reference.

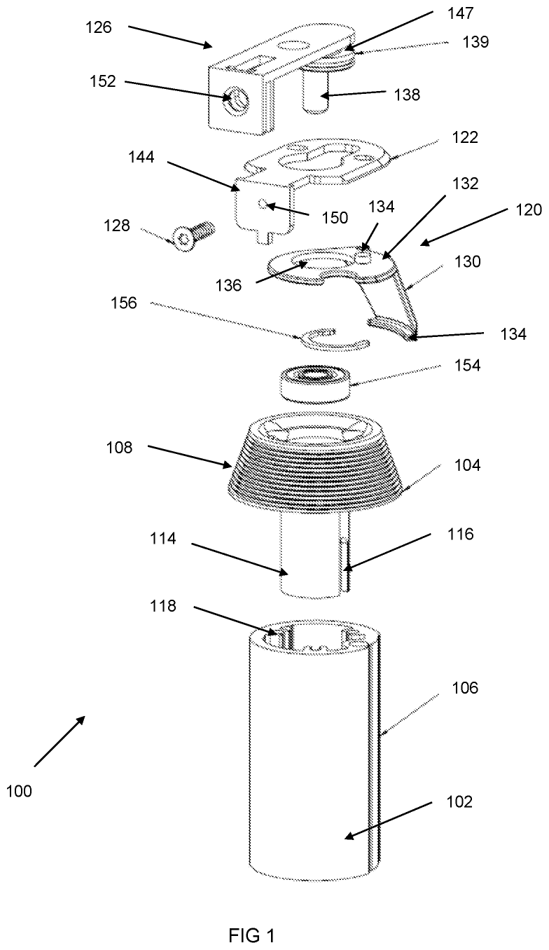

In accordance with some embodiments of the present invention, and with reference to FIG. 1, a cone and clamp assembly 100 for a screen assembly comprises a substantially vertical supporting member 102 about which a screen, such as a fabric or mesh screen, can be wound/unwound. In the embodiment shown in FIG. 1, the supporting member 102 is generally cylindrical, but in other embodiments the supporting member 102 can have other cross-sectional shapes. The supporting member 102 is hollow, but in other embodiments the supporting member can be solid, or have a combination of solid and hollow portions. The supporting member 102 is made from a single length of material, but may be made of a plurality of lengths connected together. The supporting member 102 can have a periphery comprising a spline mounting channel 106 for mounting the screen to the supporting member 102, as is known in the art.

The cone and clamp assembly 100 comprises a drum or cone 104 associated with at least one end of the supporting member 102 and the drum or cone 104 is rotatable in unison with the supporting member 102. The cone 104 has a simple frustoconical profile with one end of the cone 104 being smaller in dimension than the opposite end of the cone. The cone 104 has a frustoconical external surface 108 extending between the smaller end and the larger end.

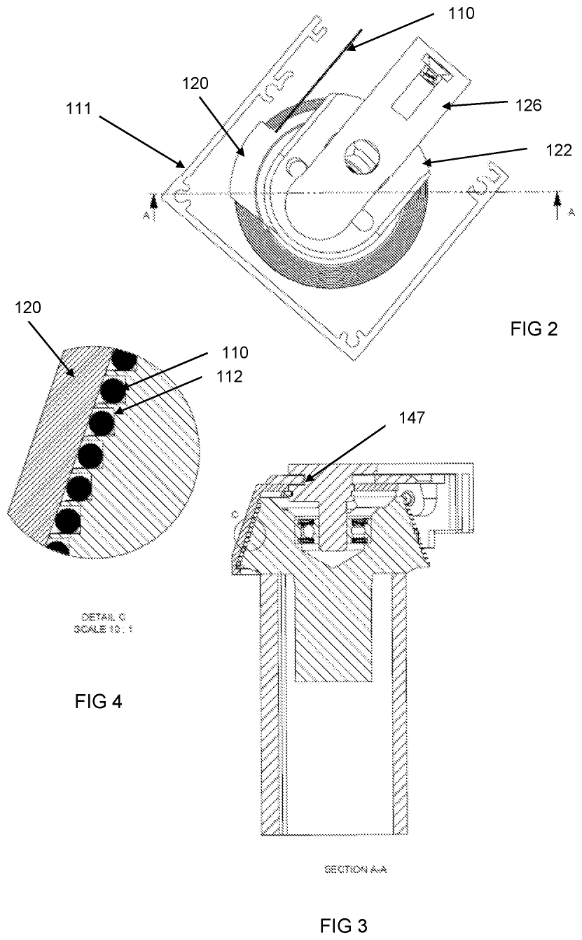

With additional reference to FIG. 2, the cone and clamp assembly 100 comprises at least one line member 110 that can be wound onto and off the cone 104. In some embodiments, the cone 104 comprises a plurality of recesses or channels 112, most clearly visible in FIGS. 4 and 7, which receive the at least one line member 110. The at least one line member 110 can be in the form of a rope, cord, cable or chain with one end fixed to the drum or cone 104. In some embodiments, the at least one line member 110 can be in the form of a “ball-chain” comprising a cord with balls attached at spaced apart intervals. In some embodiments, the at least one line member 110 is substantially circular in cross-section, but in other embodiments may be oval in cross section or some other shape. In other embodiments, at least one line member 110 may be substantially flat and in the form of a strip or strap. In some embodiments, the at least one line member 110 enters and exits the cone 104 at substantially 90 degrees to a direction of travel of the screen. FIGS. 2 and 5 show the cone and clamp assembly 100 situated in a jamb 111 of a window or door cavity.

The drum or cone 104 is attached to, or relative to an upper end of the supporting member 102. The hollow supporting member 102 receives a stem 114 extending from a base of the drum or cone 104. The stem 114 can comprise a slot or the like 116 for engagement with an internal profile 118 of the supporting member 102 such that the drum or cone 104 and the supporting member 102 rotate in unison. The drum or cone 104 tapers outwardly from a narrower diameter furthest from the supporting member 102 to a larger diameter adjacent the supporting member 102. In alternative embodiments, this can be reversed.

The cone and clamp assembly 100 comprises a clamp 120 configured to hold the at least one line member 110 relative to the external surface 108 of the cone 104 in an engaged position in the recesses or channels 112, in particular during transportation of the screen assembly or prior to operation of the screen assembly.

With additional reference to FIG. 3, the cone and clamp assembly 100 comprises a drive plate 122 engaged with a pivot pin 124 of the clamp 120. In the embodiment shown, the drive plate 122 is situated above and adjacent the clamp 120.

The cone and clamp assembly 100 comprises a cone plate 126 coupled to the cone 104 through the drive plate 122 and the clamp 120. In the embodiment shown, the cone plate 126 is situated above and adjacent the drive plate 122.

The cone and clamp assembly 100 comprises an adjustable element 128 coupled between the cone plate 126 and the drive plate 122. Adjustment of the adjustable element 128 in a first direction rotates the clamp 120 toward the external surface 108 of the cone 104 into an engaged position in which the clamp 120 holds the at least one line member 110 in place on the cone 104. Adjustment of the adjustable element 128 in a second direction rotates the clamp 120 away from the external surface 108 of the cone 104 into a disengaged position.

In some embodiments, the clamp 120 comprises an inclined surface 130 inclined at the same, or substantially the same angle as the external surface 108 of the cone 104 such that in the engaged position, the clamp 120, and in particular the inclined surface 130, abuts the external surface 108 of the cone 104, thus retaining the at least one line member 110 on the cone 104. It will be appreciated that the inclined surface 130 is also arcuate, or curved to match the curvature of the external surface 108 of the cone 104.

The clamp 120 comprises an upper surface 132 extending from a top of the inclined surface 130. The pivot pin 124 protrudes from the upper surface 132. Preferably, the pivot pin 124 is off-centre relative to the cone 104, which assists in rotating the clamp 120 toward and away from the external surface 108 of the cone 104 during engagement and disengagement, respectively, of the clamp 120. The upper surface 132 of the clamp 120 comprises an aperture 136 therethrough allowing at least a rod 138 of the cone plate 126 to pass therethrough.

In some embodiments, the clamp 120 comprises a foot portion 134 extending from a bottom of the inclined surface 130. The foot portion 134 is substantially parallel with the upper surface 132 of the clamp 120. The foot portion 134 is configured to engage an underside of the cone 104 when the clamp 120 is in an engaged position, as shown in FIG. 3. The foot portion 134 is also arcuate, or curved to match the curvature of the cone 104. The foot portion 134 assists in securely retaining the at least one line member 110 on the cone 104 when the clamp 120 is in the engaged position, as shown in FIG. 3.

In some embodiments, the drive plate 122 comprises an off-centre first aperture 140 for receiving the pivot pin 124 of the clamp 120. The off-centre first aperture 140 is substantially oval in shape thus allowing some lateral movement of the pivot pin 124 therein as well as rotational movement of the pivot pin 124. With additional reference to FIG. 9, the drive plate 122 comprises a substantially central second aperture 142. The second aperture 142 comprises a partially circular portion 143 of the same or similar diameter to the aperture 136 in the clamp 120. The partially circular portion 143 allows the rod 138 and a channelled shoulder 139 of the cone plate 126 to pass therethrough. The second aperture 142 also comprises an elongate oval portion 145, which allows linear movement of the drive plate 122 relative to the cone plate 126 and relative to the cone 104 to facilitate rotational movement of the clamp 120 towards and away from the cone 104. The drive plate 122 comprises a drive plate wall 144 extending substantially perpendicularly from the drive plate 122 for receiving the adjustable element 128.

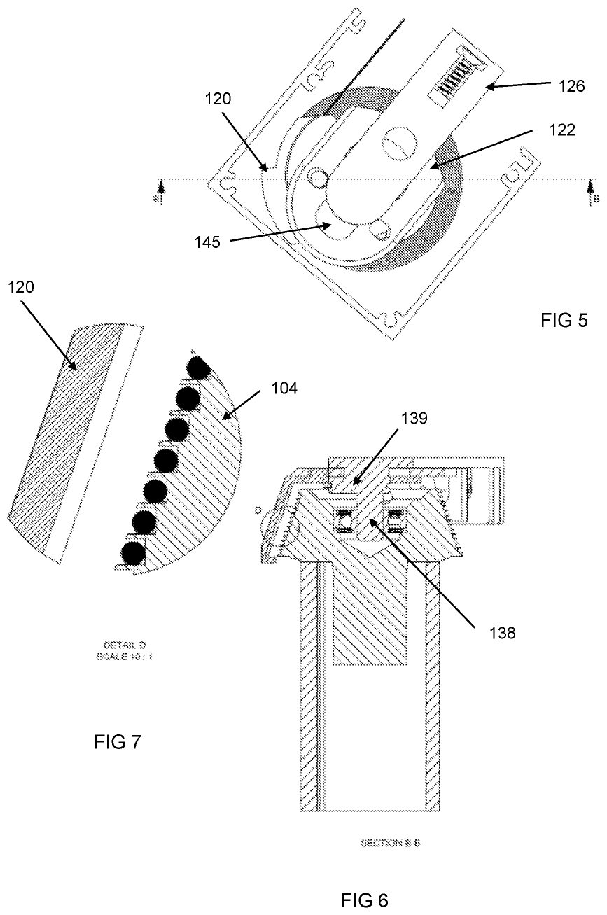

The channelled shoulder 139 depends from the cone plate 126 with a recessed portion 147 therebetween and the rod 138 depends from the channelled shoulder 139. In some embodiments, the rod 138 of the cone plate 126 passes through the second aperture 142 of the drive plate 122, through the aperture 136 of the clamp 120, and through an aperture in a bearing 154. The bearing 154 is seated within the cone 104 and is secured in place with, for example, a C-clip 156. In the assembled state, the elongate oval portion 145 of the second aperture 142 allows linear movement of the drive plate 122 within the recessed portion 147 of, and relative to the cone plate 126, for example, between the engaged position of the clamp 120 shown in FIGS. 2 to 4 and the disengaged position of the clamp 120 shown in FIGS. 5 to 7.

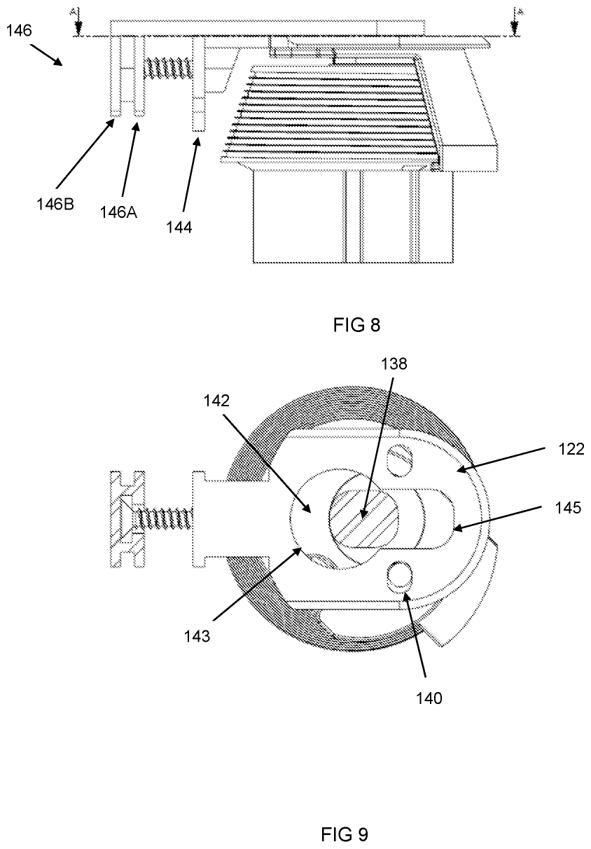

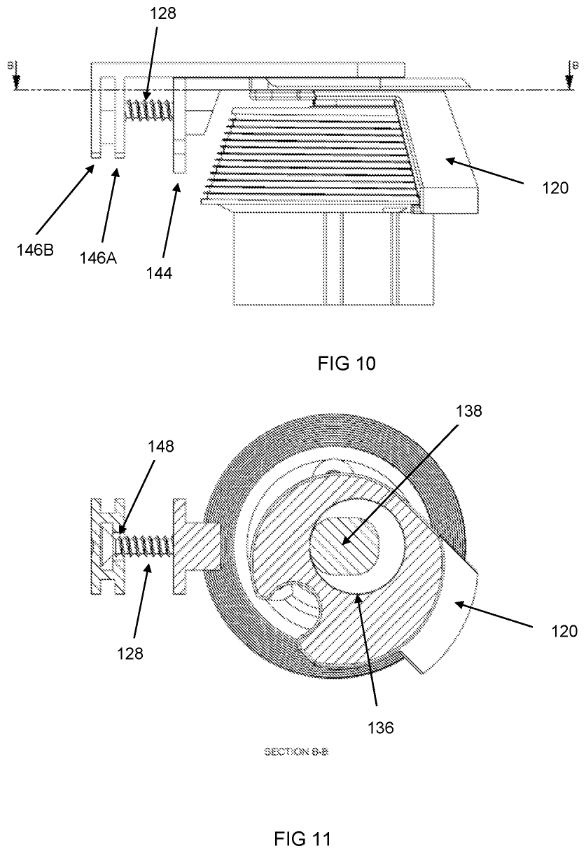

With additional reference to FIGS. 8 and 10, the cone plate 126 comprises at least one cone plate wall 146 extending substantially perpendicularly from the cone plate 126 for receiving the adjustable element 128. In the embodiments shown, the cone plate 126 comprises a pair of spaced apart cone plate walls 146A, 146B extending substantially perpendicularly from the cone plate 126 for retaining part of the adjustable element 128 therebetween.

As shown most clearly in FIGS. 8 and 10, the drive plate wall 144 of the drive plate 122 is substantially parallel with, and spaced apart from, the at least one cone plate wall 146.

In the embodiments shown, the adjustable element 128 is in the form of a screw extending through an aperture 148 in the at least one cone plate wall 146A and into an aperture 150 in the drive plate wall 144. In some embodiments, the adjustable element 128 is accessed through an aperture 152 in an outer one of the pair of spaced apart cone plate walls 146B.

FIGS. 2 to 4 show the clamp 120 in the engaged position against the external surface 108 of the cone 104 keeping the line member 110 securely in place. Rotation of the screw in one direction causes linear movement of the drive plate 122 within the recessed portion 147 of, and relative to the cone plate 126. The linear movement of the drive plate 122 causes linear and rotational movement of the clamp 120 about the off-centre pivot pin 124 away from the external surface 108 of the cone 104 to the disengaged position of the clamp 120 shown in FIGS. 5 to 7. The clamp 120 moves towards the corner of the jamb 111 where more room is available. Adjustment of the screw in the opposite direction causes linear movement of the drive plate 122 in the opposite direction and causes linear and rotational movement of the clamp 120 about the off-centre pivot pin 124 towards the external surface 108 of the cone 104. It can be seen that the clamping action of the clamp 120 is at 90 degrees to the action of the adjustable element 128.

FIGS. 9 and 11 show the cross-sectional shape of the rod 138 of the cone plate 126 according to some embodiments as a flatted oval about which the substantially circular aperture 136 of the clamp 120 moves upon adjustment of the adjustment element 128. The flatted oval shape of the rod 138 facilitates rotational and linear movement of the clamp 120 relative to the cone 104.

Another aspect of the present invention resides in a method of installing a screen assembly. According to some embodiments, the method comprises positioning a screen assembly relative to a window or door frame or jamb 111 defining an opening. The screen assembly comprises a substantially vertical supporting member 102 about which a screen can be wound/unwound and a drum or cone 104 associated with at least one end of the supporting member 102 and rotatable with the supporting member. The screen assembly comprises at least one line member 110 that can be wound onto and off the cone 104 and a clamp 120 configured to hold the at least one line member 110 relative to an external surface 108 of the cone 104 in an engaged position during transportation of the screen assembly or prior to operation of the screen assembly. The screen assembly comprises a drive plate 122 engaged with a pivot pin 124 of the clamp 120 and a cone plate 126 coupled to the cone 104 through the drive plate 122 and the clamp 120. An adjustable element 128, such as a screw, is coupled between the cone plate 126 and the drive plate 122. The adjustable element 128 has been adjusted in a first direction to rotate the clamp 120 toward the external surface 108 of the cone 104 in the engaged position. The method comprises tensioning the at least one line member 110 and adjusting the adjustable element 128 in a second direction to rotate the clamp 120 away from the external surface 108 of the cone 104 into a disengaged position.

Numerous variations from the specific embodiments described herein are envisaged that will nonetheless fall within the scope of the invention. For example, whilst a preferred material for the clamp 120 is any known suitable plastics material, in alternative embodiments, other materials can be used, such as zinc diecast.

The size of the clamp 120, and in particular the size of the inclined surface 130 can be varied. For example, if a stiffer material is used, the size of the inclined surface 130 may be reduced.

It is also envisaged that multiple materials can be used for the clamp 120. For example, a rigid material may be used to prevent the at least one line member 110 from slipping out of the recesses 112 and a soft material can be used to prevent the cone 104 from spinning during transportation of the screen assembly or prior to operation of the screen assembly.

In alternative embodiments, it is envisaged that the clamp 120 may be activated by a biasing means, such as a spring. For example, the spring can be pushed to activate (engage) and deactivate (disengage) the clamp 120.

In other embodiments, the clamp 120 can be moved with a rack and pinion mechanism.

In yet further alternative embodiments, it is envisaged that the clamp 120 can be moved in alternative directions depending on the particular application of the screen assembly and the space available. For example, the clamp 120 could be moved up and down to disengage and engage the clamp 120 with the cone 104, or vice versa.

Hence, embodiments of the present invention address or at least ameliorate at least some of the aforementioned problems of the prior art by providing a cone and clamp assembly 100 which securely and reliably holds the at least one line member 110 on the cone 104 during transportation of the screen assembly or prior to operation of the screen assembly. The cone and clamp assembly 100 is compact and therefore can be used with smaller screen assemblies as well as larger screen assemblies. The linear and rotational movement of the clamp 120 utilises the corner of the jamb where more space is available. The cooperation of the cone plate 126, the drive plate 122 and the clamp 120 ensure that the at least one line member 110 is securely and reliably held on the cone 104 and that the clamp 120 is moved clearly away from the cone 104 once the screen assembly has been installed and is ready for operation. The cone and clamp assembly 100 is also replaceable. One or more of the components of the cone and clamp assembly can easily be removed and replaced.

In this specification, adjectives such as first and second, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1. A cone and clamp assembly for a screen assembly comprising:
a substantially vertical supporting member about which a screen can be wound/unwound;
a cone associated with at least one end of the supporting member and rotatable with the supporting member;
at least one line member that can be wound onto and off the cone;
a clamp configured to hold the at least one line member relative to an external surface of the cone in an engaged position during transportation of the screen assembly or prior to operation of the screen assembly;
a drive plate engaged with a pivot pin of the clamp;
a cone plate coupled to the cone through the drive plate and the clamp; and
an adjustable element coupled between the cone plate and the drive plate;
wherein adjustment of the adjustable element in a first direction rotates the clamp toward the external surface of the cone and adjustment of the adjustable element in a second direction rotates the clamp away from the external surface of the cone.

2. The cone and clamp assembly of claim 1, wherein the clamp comprises an upper surface extending from a top of the inclined surface, wherein the pivot pin protrudes from the upper surface.

3. The cone and clamp assembly of claim 1, wherein the clamp comprises an inclined surface inclined at the same, or substantially the same angle as the external surface of the cone.

4. The cone and clamp assembly of claim 1, wherein the clamp comprises a foot portion extending from a bottom of the inclined surface, the foot portion configured to engage an underside of the cone when the clamp is in the engaged position.

5. The cone and clamp assembly of claim 1, wherein the pivot pin is off-centre relative to the cone.

6. The cone and clamp assembly of claim 2, wherein the upper surface of the clamp comprises an aperture therethrough allowing a rod of the cone plate to pass therethrough.

7. The cone and clamp assembly of claim 1, wherein the line member enters and exits the cone at substantially 90 degrees to a direction of travel of the screen.

8. The cone and clamp assembly of claim 1, wherein the drive plate comprises an off-centre first aperture for receiving the pivot pin of the clamp.

9. The cone and clamp assembly of claim 6, wherein the drive plate comprises a substantially central second aperture allowing the rod of the cone plate to pass therethrough.

10. The cone and clamp assembly of claim 1, wherein the drive plate comprises a drive plate wall extending substantially perpendicularly from the drive plate for receiving the adjustable element.

11. The cone and clamp assembly of claim 1, wherein the cone plate comprises at least one cone plate wall extending substantially perpendicularly from the cone plate for receiving the adjustable element.

12. The cone and clamp assembly of claim 11, wherein the cone plate comprises a pair of spaced apart cone plate walls extending substantially perpendicularly from the cone plate for retaining part of the adjustable element therebetween.

13. The cone and clamp assembly of claim 11, wherein the drive plate wall is substantially parallel with, and spaced apart from, the at least one cone plate wall.

14. The cone and clamp assembly of claim 11, wherein the adjustable element is in the form of a screw extending through an aperture in the at least one cone plate wall and into an aperture in the drive plate wall.

15. The cone and clamp assembly of claim 14, wherein rotation of the screw in the first direction rotates the clamp toward the external surface of the cone and adjustment of the screw in a second direction rotates the clamp away from the external surface of the cone.

16. The cone and clamp assembly of claim 11, wherein the adjustable element is accessed through an aperture in an outer one of the pair of spaced apart cone plate walls.

17. The cone and clamp assembly of claim 1, wherein the clamping action of the clamp is at 90 degrees to the action of the adjustable element.

18. The cone and clamp assembly of claim 6, wherein the rod of the cone plate passes through, and is seated in a bearing, the bearing seated within the cone and secured in place with, for example, a C-clip.

19. A method of installing a screen assembly, the method comprising:
a. positioning a screen assembly relative to a window or door frame defining an opening, the screen assembly comprising:
a substantially vertical supporting member about which a screen can be wound/unwound;
a cone associated with at least one end of the supporting member and rotatable with the supporting member;
at least one line member that can be wound onto and off the cone;
a clamp configured to hold the at least one line member relative to an external surface of the cone in an engaged position during transportation of the screen assembly or prior to operation of the screen assembly;
a drive plate engaged with a pivot pin of the clamp;
a cone plate coupled to the cone through the drive plate and the clamp; and
an adjustable element coupled between the cone plate and the drive plate, wherein the adjustable element has been adjusted in a first direction to rotate the clamp toward the external surface of the cone in the engaged position;
b. tensioning the at least one line member; and
c. adjusting the adjustable element in a second direction to rotate the clamp away from the external surface of the cone into a disengaged position.

20. The method of claim 19, wherein the adjustable element is in the form of a screw extending through an aperture in at least one cone plate wall and into an aperture in a drive plate wall.

21. The method of claim 20, wherein rotation of the screw in the first direction rotates the clamp toward the external surface of the cone and adjustment of the screw in a second direction rotates the clamp away from the external surface of the cone.
